(19) United States
(12) Patent Application Publication
(10) Pub. No.: US 2020/0115563 A1
(43) Pub. Date: Apr. 16, 2020

(54) LUMINESCENT SURFACE COVERING

(71) Applicant: HYPERFORM INCORPORATED, Rockledge, FL (US)

(72) Inventor: Jason Gardner, Melbourne Beach, FL (US)

(73) Assignee: HYPERFORM INCORPORATED, ROCKLEDGE, FL (US)

(21) Appl. No.: 16/654,465

(22) Filed: Oct. 16, 2019

Related U.S. Application Data
(60) Provisional application No. 62/746,088, filed on Oct. 16, 2018.

(51) Int. Cl. C09D 5/22; C09D 7/61; C09D 163/00

(52) U.S. Cl. CPC C09D 5/22; C09D 163/00; C09D 7/61

(57) ABSTRACT

A surface covering, which may be a non-skid covering such as a traction pad for use on a surface of a boat, kayak, watercraft, recreational vehicle, golf cart, pool deck, spa surface, swim spa surface, floor or wall surface, spa cabinet or other structure which has glow in the dark or photo-luminescent properties. The surface covering material may comprise one or more layers of material attached to each other. The surface covering material may comprise EVA foam, which may be routed. Photo-luminescent materials are applied to any surface of the surface covering. The photo-luminescent material may be mixed with a bonding agent prior to being applied to the surface covering. In an embodiment, photo-luminescent are applied to a route in the surface covering. The photo-luminescent materials may comprise a rare earth metal. The invention comprises a method for manufacturing the photo-luminescent surface covering.

### CROSS REFERENCE TO RELATED APPLICATIONS AND INCORPORATION BY REFERENCE

This non-provisional patent application is a non-provisional of, and claims benefit of priority to, U.S. provisional patent application Ser. No. 62/746,088, titled LUMINESCENT SURFACE COVERING, filed in the United States Patent and Trademark Office (USPTO) on Oct. 16, 2018, which is hereby incorporated by reference in its entirety.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISK

Not applicable.

### BACKGROUND OF THE INVENTION

### 1. Field of the Invention

The field of the invention relates generally to systems and methods for providing luminescent surface coverings for structures such as boat surfaces, recreational vehicle surfaces, swim spa surfaces, conventional spa surfaces, pool deck surfaces, golf cart surfaces, kayak surfaces, portable cooler surfaces, athletic and sport equipment, goal posts, three and four wheel motorized vehicles, watercraft surfaces, building floors and walls, and any other structure or surface.

### 2. Background Art

Flexible low surface energy substrates, such as, for example, ethylene-vinyl acetate (EVA) foam, are used for numerous applications including marine and other aquatic applications. For example, base materials in the form of traction pads comprising materials such as closed cell EVA foam are applied to boat decks and other boat surfaces such as swim platforms and helm stations, recreational vehicles, golf carts, kayaks, and watercraft to provide a padded, non-skid surface that is comfortable for a user to walk on or to rest against. In many of these applications, the vehicle, boat, recreational vehicle or other structure upon to which the base material is attached are utilized in the darkness of night. In such situations it would be advantageous that the base provide some amount of lighting, without the need for wiring, batteries, electric power-consuming devices which are susceptible to failure due to water intrusion, corrosion, the effects of weather, and other modes of failure. It would be desirable in some applications that the light be of low enough intensity so as to not impair the night vision of the user. This would be the case, for example, in the situation in which the base is applied to the decking of a boat being operated at night. In such a situation it would be desirable that the base provide enough low level light to prevent tripping from fishing or other gear in the boat, but not so much light as to impair the night vision of the operator so that the operator is still able to navigate and to see navigational markers and hazards in the water.

What is needed in the art, therefore, is an apparatus and/or method adapted to providing luminescent surface coverings for boats, recreational vehicles, swim spas, conventional spas, pool decks and surfaces, golf carts, kayaks, watercraft, building floors and walls, and any other structure or surface such that soft low level lighting is provided to a user.

### BRIEF SUMMARY OF THE INVENTION

The present invention comprises an apparatus and method that have one or more of the following features and/or steps, which alone or in any combination may comprise patentable subject matter.

The present invention overcomes the shortcomings of the prior art in that it provides a soft glow or low level lighting to a user without the need for storing or applying any electric power. The invention requires no power or stored electric energy of any kind in order to operate. The invention is a surface covering upon which photo luminescent materials are applied to a surface covering, such as a traction pad, which may, for example, comprise a compressible closed cell foam such as EVA or PE foam, resulting in a surface covering that glow-in-the-dark properties. The photo luminescent materials may be applied to the surface covering in such manner as to provide a desired level of lighting to a user. In an embodiment, the photo luminescent materials may be applied to the surface covering in such manner as to provide a desired level of illumination in specific areas of the base, for example in areas for which some night illumination is desired, or alternatively the photo luminescent materials may be applied to the surface covering in such manner as to provide a desired ornamental pattern or other decoration.

A luminescent surface covering of the invention may be applied to or form a part of any structure, such as, for example and not by way of limitation, marine products such as boats, docks, decks, surfboards, paddle boards, kayaks, canoes, jet skis, and the like; adventure products such as three or four-wheel powered vehicles, duck blinds, tree stands, portable coolers, and the like; athletic arenas; goal posts; skate parks; pools and pool decks; spas and spa decks; swim spas; animal trailers; flooring generally; and any other structure for which is may be desired to include a closed-cell foam covering with luminescent properties. In embodiments the surface covering of the invention may be used on any surface for which is desired to provide a protective covering, a shock-absorbing covering, a decorative covering, a sound-deadening covering, a texturing covering, or any combination of the foregoing.

### BRIEF DESCRIPTION OF THE DRAWINGS

The accompanying drawings, which are incorporated into and form a part of the specification, illustrate one or more embodiments of the present invention and, together with the description, serve to explain the principles of the invention. The drawings are only for the purpose of illustrating the preferred embodiments of the invention and are not to be construed as limiting the invention. In the drawings:

FIG. 1 depicts a side view of an embodiment of the invention, showing a cross section of the surface covering and various locations for applying a photo luminescent material; and depicting that the surface covering may comprise one or more layers of material.

FIG. 2 depicts an embodiment of the invention, in which the surface covering has been applied to a boat swim platform. The photo luminescent material may be applied in routed areas for providing low level lighting, for providing ornamental features to the surface covering, or for any other purpose.

In the figures, like callouts refer to like features.

### DETAILED DESCRIPTION OF THE INVENTION

The following documentation provides a detailed description of the invention.

Although a detailed description as provided in the attachments contains many specifics for the purposes of illustration, anyone of ordinary skill in the art will appreciate that many variations and alterations to the following details are within the scope of the invention. Accordingly, the following preferred embodiments of the invention are set forth without any loss of generality to, and without imposing limitations upon, the claimed invention. Thus the scope of the invention should be determined by the appended claims and their legal equivalents, and not merely by the preferred examples or embodiments given.

As used herein, “surface covering” or “traction pad” means any covering that is intended to be attached or applied to any surface to provide a desired effect such cushioning to reduce impact; sound deadening; decoration, texturing or other appearance enhancing features; or any other desired effect. The covering does not have to permanently attach to the structure to which is applied. A surface covering may comprise one or more layers of material, which may be sheet material.

As used herein, “luminescent material”, “glow in the dark material” and “photo-luminescent material” include within their meaning any material that comprises a pigment or material that releases energy in the form of light and may include, for example, photo-luminescent pigments or materials, phosphorescent pigments or materials, fluorescent pigments or materials, chemi-luminescent pigments or materials, ultra violet (UV) glow pigments and materials, radioactive materials and any other pigment or material that emits light, using any process, pigment or material known in the art to emit light. “Glow in the dark material” and “photo-luminescent material” also include within their meaning pigments or materials comprising alkaline earth metal aluminate (AEA) made from high purity inorganic materials and doped with “rare earth” metals (lanthanoids); pigments or materials comprising zinc sulfide pigments or materials; pigments or materials comprising zinc sulfide doped with a dopant such as, for example, europium such as in SrAl2O4:Eu; copper-activated zinc sulfide pigments or materials, pigments or materials comprising copper-activated zinc sulfide doped with a dopant such as, for example, europium such as in SrAl2O4:Eu; strontium aluminate pigments or materials; pigments or materials comprising strontium aluminate oxide doped with rare earth impurities such as Europium; pigments or materials comprising strontium aluminate known as SRA, SrAl, or SrAl2O4; radium pigments or materials; tritium pigments or materials; pigments or materials comprising barium sulfide; or any other material that emits light. Thus the definition of glow in the dark materials includes pigments or materials that emit light when mixed with other materials such as in glow sticks; pigments or materials that emit light for a period of time after being charged from a light source by being exposed to a light source such as for example any light source, sunlight, or an UV lights such as a black light; ultra violet (UV) glow pigments and materials that glow, or emit light in the visible spectrum, when subjected to UV light such as a black light; and pigments or materials that emit light through spontaneous radiation such as radium. Examples of ultra violet (UV) glow pigments and materials include but are not limited to UV phosphorous pigments or materials, which may emit any wavelength of visible light including but not limited to 450 nm, 420 nm, 505 nm, 510 nm, 545 nm, 590 nm, 615 nm, 500 nm, or 595 nm. “Glow in the dark material” and “photo-luminescent material” also include within their meaning rare earth-alkaline mineral crystals. In an embodiment, “luminescent”, “glow in the dark materials” and “photo-luminescent materials” may be free from radioactive additives. In an embodiment, “luminescent”, “glow in the dark materials” and “photo-luminescent materials” may be re-charged an infinite number of times. In an embodiment, “glow in the dark materials” and “photo-luminescent materials” may be toxicologically harmless.

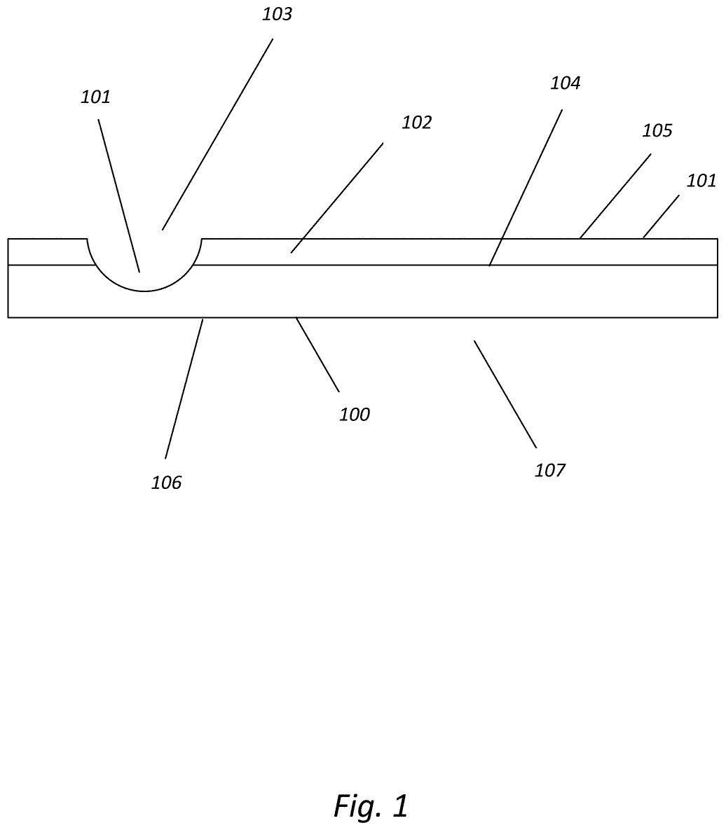

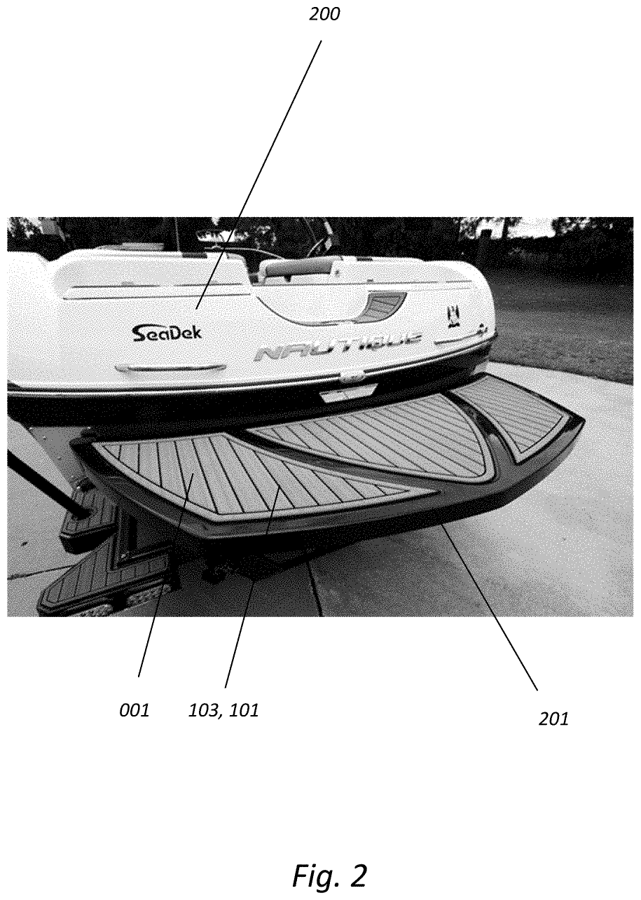

Referring now to FIGS. 1 and 2, a cross section view of an embodiment of the invention is depicted. A surface covering 001, which may be a traction pad or deck pad installed on a boat surface for providing traction, reducing impact i.e. cushioning or absorbing shock, or for decoration may be comprised of at least one layer of material or a plurality of layers of material. In the embodiment shown in FIG. 1, base 001 is depicted as comprising two layers of material, first layer of material 102 and second layer of material 108, which may be attached to one another at boundary surface 104 by any means known in the art, for example and not by way of limitation, chemical bonding using an adhesive or heat lamination. A portion 103 may be routed in the surface covering. In the exemplary, non-limiting depiction of the two-layer base shown in FIG. 1, the routed portion is shown as extending through first layer of material 102 and into second layer of material 108. Such routing may be advantageous, for example, if first layer 102 and second layer of material 108 are each of a different color. In such case, the routing through first layer of material 102 exposes may expose the color of second layer of material 108 creating a visible pattern as seen from the direction of 103. In practice, base 001 may comprise any number of layers of material. First layer of material 102 may have an upper, visible surface 105 when base 001 is attached to a boat or other structure 107 at surface 100. In an embodiment, the glow in the dark material or photo-luminescent material 101 may be applied to upper surface 105 of first layer of material 102 to create any glow in the dark or photo-luminescent pattern desired.

Referring now to FIG. 1, a glow in the dark material or photo-luminescent material 101 may be deposited in the route 103. The glow in the dark material or photo-luminescent material 101 may cover any portion of route 103; i.e., either leaving some of route second layer of material 108 showing in route 103, or covering up second layer 108 altogether such that second layer of material 108 is not visible as seen from the direction of 103.

The glow in the dark material or photo-luminescent material 101 may be deposited directly onto any surface of the surface covering, such as visible surface 105, or may be included in the material of the surface covering itself at time of manufacture such as, in the case of EVA foam, in the mixing of the chemical composition that is used to create, or “blow”, the EVA closed cell foam material.

A surface covering of the invention may attach to a surface of a structure using chemical bonding (i.e. adhesive) which, in embodiments, comprise an adhesive film, or by using at least on snap that forms a part of a mating snap pair captured in the surface covering, which is adapted to be received by at least one complementary snap receiving structure forming a second part of the mating snap pair which is attached to a surface upon which is desired to attach the surface covering of the invention. The invention may comprise any number of snaps for attaching to such surface.

Referring now to FIG. 2, an embodiment of the invention is depicted in which a deck pad of the invention has been applied to the swim platform 201 of a boat 200. It can be seen in FIG. 2 that the routed areas 103 may be used form any pattern or decorative configuration desired, thus providing a glowing pattern or decorative configuration when glow in the dark material or photo-luminescent material 101 is deposited in the route 103. When the glow in the dark material or photo-luminescent material 101 has been charged, a low level glow of light will appear in the shape of 103, which may take any shape or configuration desired by the user. This would have significant advantage for a night user of the swim platform, providing an extra measure of safety in order to prevent a user from accidentally falling off the swim platform due to a misstep in the darkness.

In an embodiment, the glow in the dark material or photo-luminescent material 101 may be mixed with a bonding agent such as, for example, an epoxy, prior to being applied to route 103 or to the upper surface 105 of first layer of material 102. The use of the bonding agent may provide additional chemical bonding of the glow in the dark material or photo-luminescent material 101 to the base layers of material. This additional bonding is useful to prevent the glow in the dark material or photo-luminescent material 101 from wearing off, or being removed, due to normal use, wear and tear, weather or washings of the surface to the base is attached. The bonding agent may be a clear casting epoxy resin or coating epoxy resin.

In embodiments, any visible surface of a surface covering of the invention may comprise texturing such as, for example, a brushed texture, an pattern-embossed texture, a smooth texture, a cross-brushed texture, a grooved texture or any other texture that comprises modification of the visible surface by milling, heating, brushing, embossing or any other process.

In embodiments, the photo-luminescent material 101 may form designs, lettering, logos, patterns, or any other desired informational or decorative pattern or shape in the layer of material upon which is applied. For example, a company brand or logo may be formed by the application of the photo-luminescent material 101 in a surface covering of the invention for advertising or branding purposes.

The invention may comprise a method of manufacturing a photo-luminescent surface covering, comprising providing a first layer of material; providing a second layer of material; attaching the first layer of material and the second layer of material at a boundary between them; routing a route, or cutout, through the first layer of material and into the second layer of material; mixing a photo-luminescent with a bonding agent to create a photo-luminescent mixture; and depositing the photo-luminescent mixture into the route or cutout. In an embodiment, the first layer of material and said second layer of material may be EVA or PE foam. In an embodiment, the step of attaching may be further defined as being selected from the group consisting of chemical bonding or heat lamination. In an embodiment, the step of attaching may be further defined as being selected from the group consisting of chemical bonding or heat lamination. The photo-luminescent material may be further defined as comprising a rare earth metal. The method of the invention may also further include the step of forming a company identifier, such as a trademark or logo, on the surface or surfaces to which the photo-luminescent material is applied or routing a company identifier, such as a trademark or logo, on a surface of the surface covering.

In an embodiment, the first layer of material may be characterized has comprising a first color, and said second layer of material is characterized has comprising a second color.

In embodiments, a method of the invention may further comprise the step of attaching a photo-luminescent surface covering of the invention to one of a surface of a marine product, a surface of a spa cabinet, a surface of a pool, a surface of a portable cooler, a surface of a golf cart, or a surface of a swim spa.

In an embodiment, base 001 may comprise at least one layer of material, but may also comprise a plurality of layers of material. The layers of material may comprise flexible low surface energy substrates, such as, for example, closed cell ethylene-vinyl acetate (EVA) foam or closed cell Polyethylene (PE) foam, such as are used for numerous applications including marine and other aquatic applications. The photo luminescent system and method described and claimed herein is not limited by the type of material comprising the layer(s) of material of the surface covering.

What is claimed is:

1. A photo-luminescent surface covering, comprising:
a first layer of material, said first layer of material having an upper surface;
a route disposed in said upper surface, and
a photo-luminescent material deposited in said route.

2. The photo-luminescent surface covering of claim 1, further comprising a second layer of material, wherein said first layer of material is attached to said second layer of material at a boundary formed between said first layer of material and said second layer of material, and wherein said route extends through said first layer of material into said second layer of material.

3. The photo-luminescent surface covering of claim 1, wherein said first layer of material comprises EVA or PE foam.

4. The photo-luminescent surface covering of claim 1, wherein said first layer of material and said second layer of material each comprise EVA or PE foam.

5. The photo-luminescent surface covering of claim 1, wherein the photo-luminescent material is characterized as being mixed with an epoxy prior to being deposited in said route.

6. The photo-luminescent surface covering of claim 2, wherein the photo-luminescent material is characterized as being mixed with an epoxy prior to being deposited in said route.

7. The photo-luminescent surface covering of claim 3, wherein the photo-luminescent material is characterized as being mixed with an epoxy prior to being deposited in said route.

8. The photo-luminescent surface covering of claim 4, wherein the photo-luminescent material is characterized as being mixed with an epoxy prior to being deposited in said route.

9. The photo-luminescent surface covering of claim 1, wherein said photo-luminescent material is further defined as comprising a rare earth metal.

10. The photo-luminescent surface covering of claim 2, wherein said first layer of material is characterized has comprising a first color, and said second layer of material is characterized has comprising a second color.

11. The photo-luminescent surface covering of claim 1, having an attaching surface for attaching to a structure, wherein said attaching surface further comprises an adhesive.

12. A photo-luminescent surface covering, comprising:
a first layer of material, said first layer having an visible surface; and
a photo-luminescent material deposited on said visible surface.

13. The photo-luminescent surface covering of claim 12, having an attaching surface for attaching to a structure, wherein said attaching surface further comprises an adhesive.

14. A method of manufacturing a photo-luminescent surface covering, comprising:
providing a first layer of material;
providing a second layer of material;
attaching said first layer of material and said second layer of material at a boundary between them;
routing a route through said first layer of material and into said second layer of material;
mixing a photo-luminescent with a bonding agent to create a photo-luminescent mixture; and
depositing said photo-luminescent mixture in said route.

15. The method of claim 14, wherein said first layer of material and said second layer of material are EVA or PE foam.

16. The method of claim 14, wherein said step of attaching is further defined as being selected from the group consisting of chemical bonding or heat lamination.

17. The method of claim 14, wherein said step of attaching is further defined as being selected from the group consisting of chemical bonding or heat lamination.

18. The method of claim 14, wherein said photo-luminescent material is further defined as comprising a rare earth metal.

19. The method of claim 14, wherein said first layer of material is characterized has comprising a first color, and said second layer of material is characterized has comprising a second color.

20. The method of claim 14, further comprising the step of attaching said photo-luminescent surface covering to one of a surface of a marine product, a surface of a spa cabinet, a surface of a pool, or a surface of a swim spa.
